(19) United States
(12) Patent Application Publication
(10) Pub. No.: US 2011/0211270 A1
(43) Pub. Date: Sep. 1, 2011

(54) ELECTRONIC DEVICE

(75) Inventor: Tsuyoshi Okumura, Osaka (JP)

(73) Assignee: SANYO ELECTRIC CO., LTD., Osaka (JP)

(21) Appl. No.: 13/035,172

(22) Filed: Feb. 25, 2011

(30) Foreign Application Priority Data
Feb. 26, 2010 (JP) 2010-041841

(51) Int. Cl. G02B 7/00; G02B 5/22

(52) U.S. Cl. 359/892; 359/894

(57) ABSTRACT

In an electronic device according to the present invention, an optical element 6 is arranged inside a casing, a transmissive panel member is mounted on a front surface of the casing, and a transmission portion is provided in the transmissive panel member to guide a light beam into the optical element or transmit a light beam emitted from the optical element. A thin-walled portion having a smaller thickness than an average thickness of the transmissive panel member constitutes the transmission portion of the transmissive panel member.

Japanese Patent Application No. 2010-41841 on which the priority claim of this patent application is based is incorporated herein by reference.

### BACKGROUND OF THE INVENTION

1. Field of the Invention

The present invention relates to an electronic device such as a television receiver.

2. Description of the Related Art

Generally, in electronic devices such as television receivers, an optical element such as an LED and a light receiving element is incorporated therein to provide some information to a user by a light beam emitted from the optical element, or to perform some control by receiving an infrared remote control signal from a user at the optical element.

For example, in a television receiver shown in FIG. 6, an optical element 6 such as an LED which lights up when power is ON, for example, is arranged inside a casing 10 including a front cabinet 12 and a back cabinet 13. A transmissive panel member 4 made of colored synthetic resin is mounted on the front surface of the front cabinet 12. A decorative effect is thereby given to the casing 10.

A light guide member 5 is also mounted through a through hole 14 of the front cabinet 12 between the optical element 6 and the transmissive panel member 4 inside the casing 10. A distal end portion of the light guide member 5 is inserted into a through hole 41 formed in the transmissive panel member 4.

In the aforementioned television receiver, when the optical element 6 lights up, a light beam emitted from the optical element 6 is transmitted through the light guide member 5, and emitted frontward from the through hole 41 of the transmissive panel member 4.

In the television receiver shown in FIG. 6, however, the through hole 41 is formed in the transmissive panel member 4. Thus, resin moldability obtained when the transmissive panel member 4 is integrally molded from the synthetic resin is impaired, and a so-called weld line occurs, so that the appearance of the transmissive panel member 4 is spoiled.

### SUMMARY OF THE INVENTION

An electronic device according to the present invention is an electronic device, wherein an optical element 6 is arranged inside a casing 1, a transmissive panel member 3 is mounted on a front surface of the casing 1, and a transmission portion 31 is provided in the transmissive panel member 3 to guide a light beam into the optical element 6 or transmit a light beam emitted from the optical element 6, a thin-walled portion having a smaller thickness than an average thickness of the transmissive panel member 3 constituting the transmission portion 31 of the transmissive panel member 3.

### BRIEF DESCRIPTION OF THE DRAWINGS

FIG. 1 is a perspective view of a television receiver according to one embodiment of the present invention;

FIG. 2 is a perspective view illustrating a state in which a transmissive panel member is removed from a casing in the television receiver;

FIG. 3 is a front view illustrating a main portion of the transmissive panel member;

FIG. 4 is a back view illustrating a main portion of the transmissive panel member;

FIG. 5 is a sectional view illustrating a main portion of the television receiver; and

FIG. 6 is a sectional view illustrating a main portion of a conventional television receiver.

### DETAILED DESCRIPTION OF THE PREFERRED EMBODIMENTS

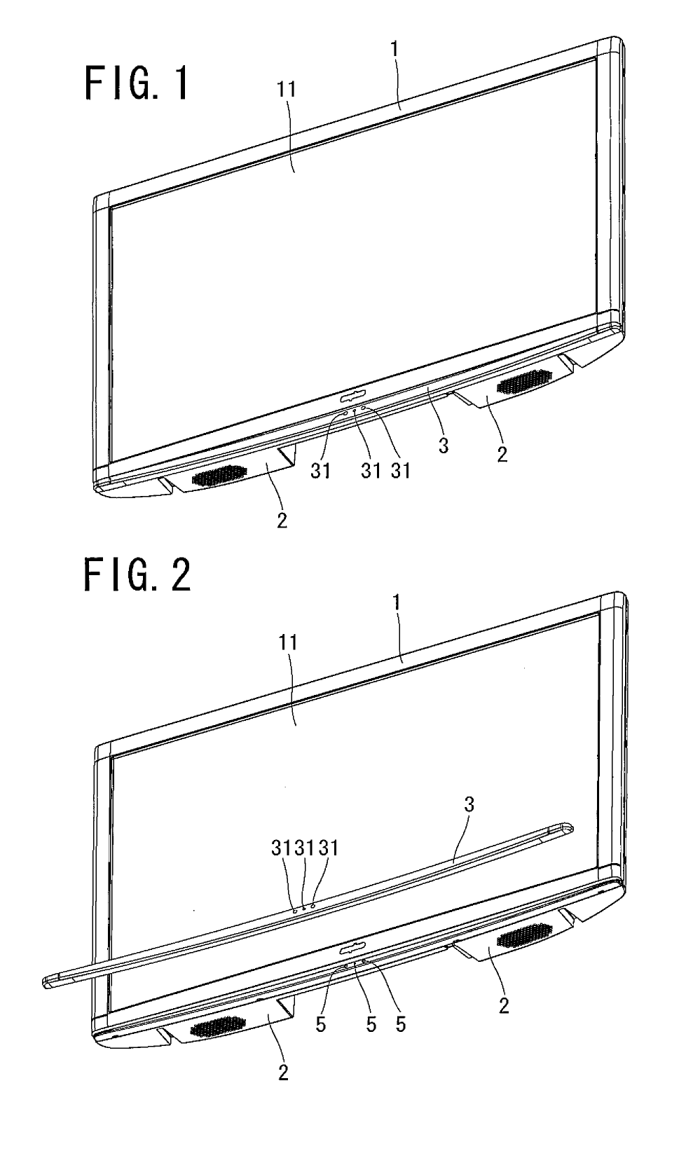

In the following, an embodiment in which the present invention is applied to a television receiver will be described in detail based on the drawings. In a television receiver according to one embodiment of the present invention, a transmissive panel member 3 made of colored synthetic resin is mounted so as to cover a lower side portion of a casing 1 including a display screen 11 as shown in FIGS. 1 and 2, so that a design effect is given to the casing 1. A pair of right and left speakers 2 and 2 are arranged in a bottom portion of the casing 1.

Three transmission portions 31, 31, and 31 are provided in the transmissive panel member 3. The three transmission portions 31, 31, and 31 allow brightness detection, lighting display at the time of power ON, and reception of an infrared remote control signal.

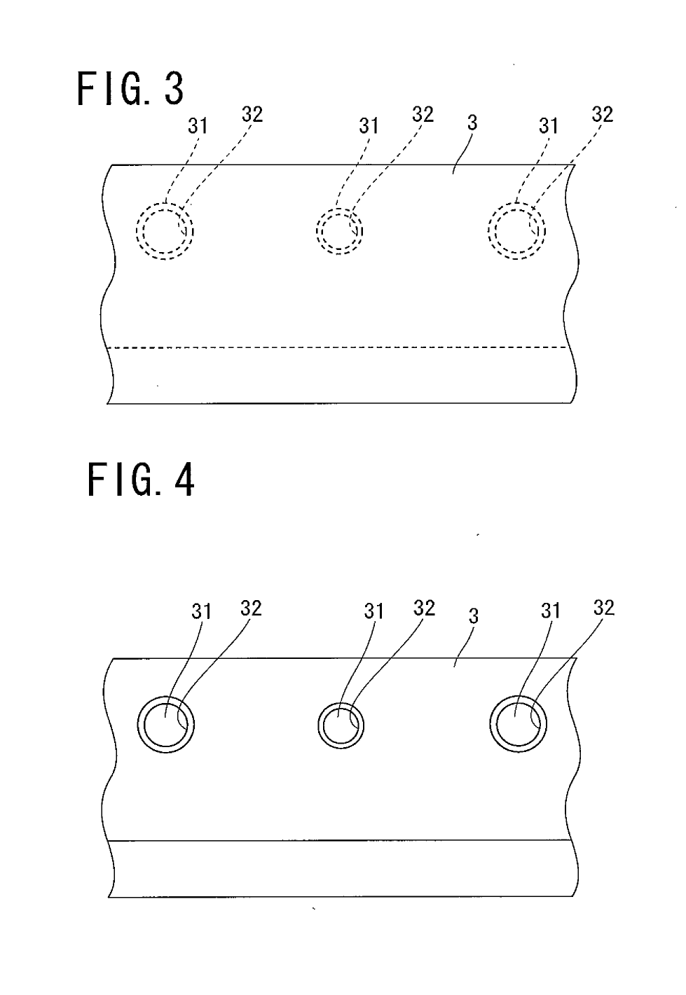

A concave portion 32 is formed in the back surface of the transmissive panel member 3 to constitute each of the three transmission portions 31, 31, and 31 of the transmissive panel member 3 as shown in FIGS. 3 and 4. A sufficient transmissive property is obtained by reducing the thickness of each of the transmission portions 31 to be smaller than the average thickness of the transmissive panel member 3.

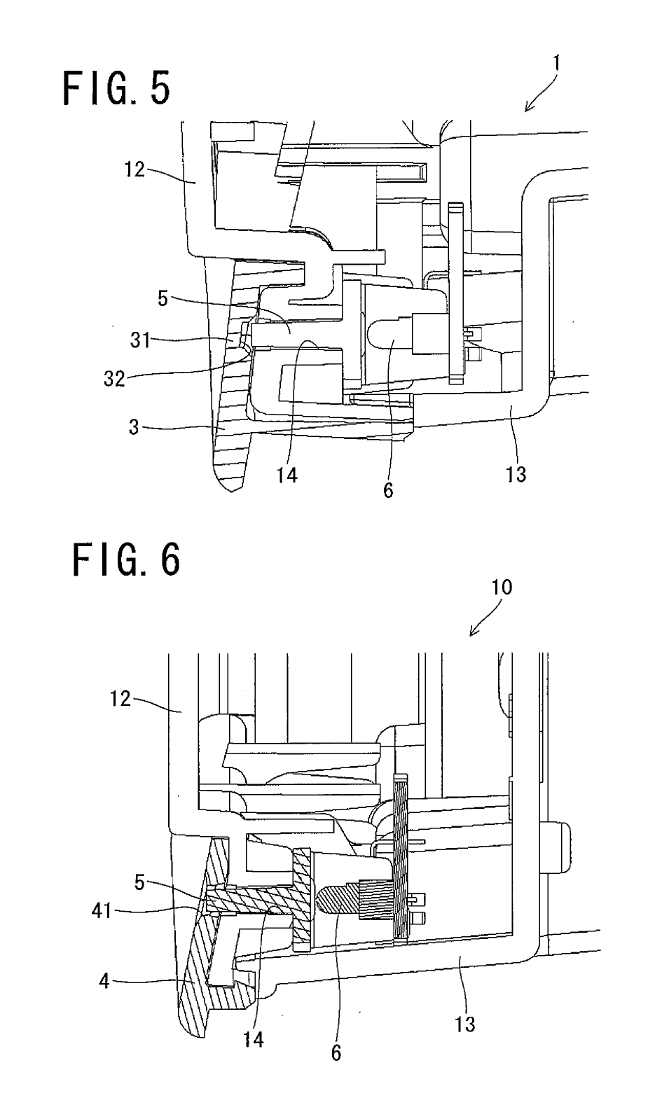

For example, to allow the lighting display at the time of power ON, an optical element 6 including an LED is mounted facing one of the transmission portions 31 of the transmissive panel member 3 inside the casing 1 as shown in FIG. 5. A light guide member 5 is mounted through a through hole 14 of a front cabinet 12 between the optical element 6 and the one transmission portion of the transmissive panel member 3. A distal end portion of the light guide member 5 is inserted into the concave portion 32 of the transmissive panel member 3.

To allow the brightness detection and the reception of an infrared remote control signal, the same configuration as the configuration to allow the lighting display shown in FIG. 5 is employed.

In the aforementioned television receiver, a thin-walled portion constitutes the transmission portion 31 of the transmissive panel member 3. Thus, the resin moldability of the transmissive panel member 3 is better than that in a conventional electronic device where a through hole constitutes a transmission portion, so that occurrence of a weld line in the transmissive panel member 3 is suppressed.

It should be noted that the configuration of each portion of the present invention is not limited to that in the aforementioned embodiment, and various modifications may be made therein by a person skilled in the art without departing from the spirit of the present invention as expressed in the claims. The present invention is also not limited to the television receiver, and may be applied to various electronic devices.

What is claimed is:

1. An electronic device, wherein an optical element is arranged inside a casing, a transmissive panel member is mounted on a front surface of the casing, and a transmission portion is provided in the transmissive panel member to guide a light beam into the optical element or transmit a light beam emitted from the optical element, a thin-walled portion having a smaller thickness than an average thickness of the transmissive panel member constituting the transmission portion of the transmissive panel member.

2. The electronic device according to claim 1, wherein a concave portion is formed in a back surface of the transmissive panel member to constitute the transmission portion of the transmissive panel member, a light guide member is arranged between the concave portion and the optical element, and a distal end portion of the light guide member is inserted into the concave portion of the transmissive panel member.

3. The electronic device according to claim 1, wherein the transmissive panel member is an integrally molded article of colored synthetic resin.

4. The electronic device according to claim 3, wherein a concave portion is formed in a back surface of the transmissive panel member to constitute the transmission portion of the transmissive panel member, a light guide member is arranged between the concave portion and the optical element, and a distal end portion of the light guide member is inserted into the concave portion of the transmissive panel member.
